(19) United States
(12) Patent Application Publication
(10) Pub. No.: US 2011/0231282 A1
(43) Pub. Date: Sep. 22, 2011

(54) Online Evaluation System and Method

(75) Inventor: Qingzhu Dai, Hangzhou (CN)

(73) Assignee: Alibaba Group Holding Limited

(21) Appl. No.: 12/663,256

(22) PCT Filed: Aug. 11, 2009
(86) PCT No.: PCT/US09/53429

§ 371 Date: Dec. 4, 2009

(30) Foreign Application Priority Data
Aug. 11, 2008 (CN) 200810147003.2

(51) Int. Cl. G06Q 30/00

(52) U.S. Cl. 705/26.35

(57) ABSTRACT

An online evaluation system and method compute multiple types of evaluation parameters including at least an overall evaluation type and a categorical evaluation type using evaluation data received from users. The system calls the multiple types of evaluation parameters upon receiving a request for evaluation information of the user of the second type from a web page, and sends the multiple types of evaluation parameters to a front end of the system to be displayed to a user who has requested the information. The multiple types of evaluation parameters are displayed on a web page using a format pre-configured by the system. Using the method and system help achieve a more comprehensive evaluation of the user, and provide more detailed, more accurate and more reliable evaluation information.

### RELATED APPLICATIONS

This application is a national stage application of international patent application PCT/US09/53429 filed Aug. 11, 2009, claiming priority from Chinese patent application, Application No. 200810147003.2, filed Aug. 11, 2008, both entitled “ONLINE EVALUATION SYSTEM AND METHOD”, which applications are hereby incorporated in their entirety by reference.

### TECHNICAL FIELD

The present disclosure relates to a field of network information, and particularly relates to online evaluation systems and methods.

### BACKGROUND

Existing large-scale e-commerce websites normally have a set of evaluation methods, of which one typical method is described as follows.

Upon completing an e-commerce transaction, a website invites a buyer to evaluate a seller by clicking options, which may include several types such as good ratings, average ratings, and poor ratings. The buyer makes a selection based on his/her experience of the transaction. If the buyer is satisfied with the transaction, a good rating is usually selected. If not satisfied, a poor rating may be selected. If the buyer does not conduct evaluation, a system defaults the transaction's rating to be a good rating. Using this method, each seller gradually builds up an evaluation data. The website translates this data into certain indicators such as rate of good ratings and seller's credibility score.

A rate of good ratings is calculated by dividing number of past good ratings the seller has received by the total number of ratings, and is represented in terms of a percentage. Credibility score is calculated based on an accumulative total of good ratings. For example, receiving a good rating adds a point to the credibility, and a poor rating reduces a point from the credibility. No point is received for an average rating.

If, for instance, a seller has completed one hundred seller transactions since registration and received ninety-seven good ratings, two average ratings, and one poor rating, then the seller has the following rating and score:

rate of good ratings=97/(97+2+1)=97%; and

credibility score=97×1+2×0+1×(−1)=96 points.

After the seller's rating score is calculated, the website translates his/her credibility score into a certain ranking class or ranking based on certain rules. Total number of ranking is normally in between ten and fifteen, with each ranking being represented by a certain icon. A clear correspondence relationship exists between a ranking and a credibility score. For example, a score above ninety-six points may correspond to a third ranking.

As such, the website translates a seller's good, average and poor ratings received from buyers into three indicators of the seller: a rate of good ratings, an overall credibility score, and a ranking. These three indicators become long-term indicators of the seller on the website. A buyer usually judges the seller based on these three indicators, and then decides whether a purchase will be made.

However, the existing evaluation methods are over-simplified, and as a result both transaction parties may fail to comprehensively understand spending of the other party.

### SUMMARY

An online evaluation system and method compute multiple types of evaluation parameters including at least an overall evaluation type and a categorical evaluation type using evaluation data received from users. The system calls the multiple types of evaluation parameters upon receiving a request for evaluation information of the user of the second type from a web page, and sends the multiple types of evaluation parameters to a front end of the system to be displayed to a user who has requested the information. The multiple types of evaluation parameters are displayed on a web page using a format pre-configured by the system.

In one embodiment, the evaluation system is used on e-commerce system to evaluate sellers by buyers and vice versa.

The overall evaluation type multiple general evaluation parameters may include a total number of good ratings, a total number of poor ratings, and an average rate of poor ratings. The categorical evaluation type may include specific evaluation parameters each representing a specific category of user performance. The multiple types of evaluation parameters may further include one or more evaluation parameters based on normal transaction data. The multiple types of evaluation parameters may further include one or more evaluation parameters based on post-transaction event records.

The multiple types of evaluation parameters may computed for a plurality of time intervals and displayed to the user. In one embodiment, the multiple types of evaluation parameters displayed on the website do not include an overall credibility score of the user of the second type.

To display the multiple types of evaluation parameters on a web page through the front end, the system may configure a format, and allow the multiple types of evaluation parameters to be displayed on the web page according to the format.

In one embodiment, the online evaluation system has a server computer which is adapted for receiving evaluation data submitted by users of a first type to evaluate a user of a second type; computing multiple types of evaluation parameters including at least an overall evaluation type and a categorical evaluation type using the received evaluation data; calling the multiple types of evaluation parameters upon receiving a request for evaluation information of the user of the second type from a web page; sending the multiple types of evaluation parameters to a front end; and displaying the multiple types of evaluation parameters on a web page through the front end.

The disclosed system and method provide a more comprehensive evaluation of both parties of a transaction. Through obtaining and displaying multiple types of evaluation parameters including both an overall evaluation type and a categorical evaluation type in various time periods, the system and the method may provide more objective and reliable evaluation information to users.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

FIG. 1 shows a schematic structural diagram an exemplary evaluation system according to one embodiment.

FIG. 2 shows an online evaluation system using an example of a buyer evaluating a seller according to one embodiment.

FIG. 3 shows an exemplary display of various types of evaluation parameters of a seller according to one embodiment.

FIG. 4 shows an exemplary process in which a seller is evaluated by buyers according to one embodiment.

FIG. 5 shows an exemplary display of various types of evaluation parameters of a buyer according to one embodiment.

### DETAILED DESCRIPTION

In existing evaluation methods, an evaluation system includes an evaluation request module, a data collection module, a computing module, and a web page display module. Each time a transaction occurs, the evaluation request module invites a buyer to evaluate a seller Clicking options which may include several types such as good rating, average rating, and poor rating. Upon completing the evaluation, evaluation data is stored in a database. When called for, the data collection module reads the evaluation data from the database, and sends the evaluation data to the computing module. Based on the received evaluation data, the computing module computes a rate of good ratings, an overall credibility score and a ranking, which are sent to the web page display module to be displayed on relevant web page by the web page display module.

However, the existing evaluation methods provide insufficient amount of that election information, and may not be able to obtain a comprehensive and objective evaluation.

The method and system disclosed herein aim to overcome such efficiency. The present disclosure is described in details below using accompanying figures and exemplary embodiments.

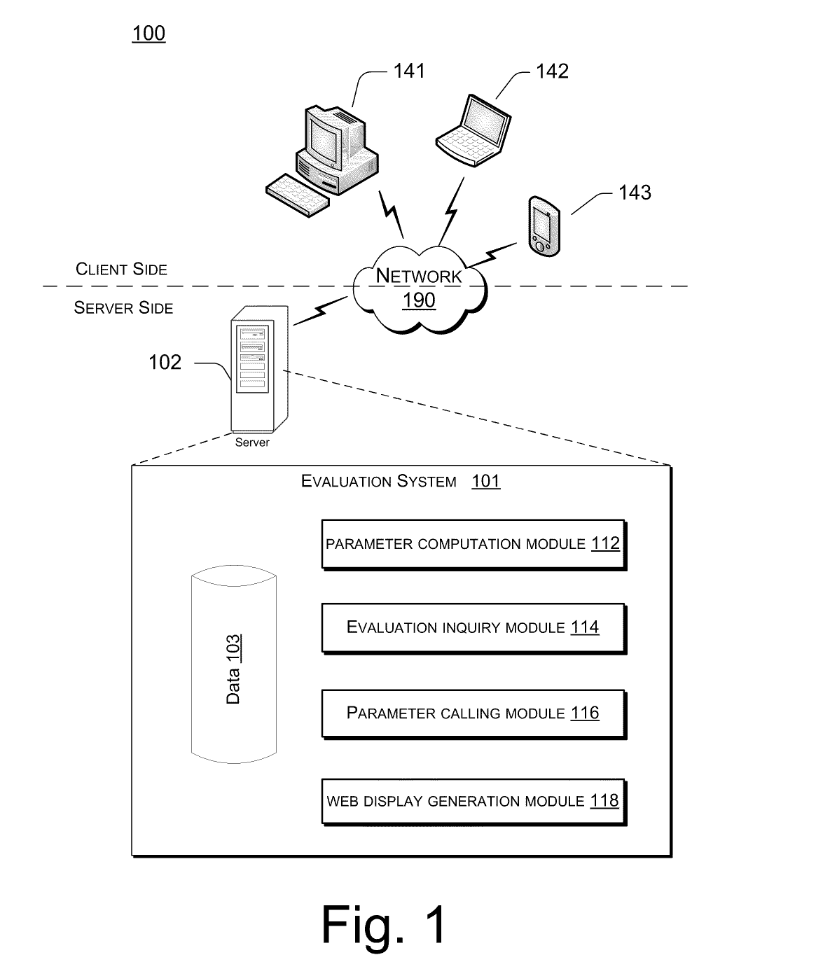

FIG. 1 shows a schematic structural diagram of an exemplary evaluation system 101 in an exemplary embodiment 100. Exemplary evaluation system 101 is in exemplary environment 100 for implementing the method of the present disclosure. In illustrated, in environment 100, some components reside on a client side and other components reside on a server side. However, these components may reside in multiple other locations. Furthermore, two or more of the illustrated components may combine to form a single component at a single location.

The evaluation system 101 is connected to client-side computing devices (client terminals) such as 141, 142 and 143 through network(s) 190, such that users (not shown) may access the evaluation system 101 through the client-side computing devices. In one embodiment, computing device 102 is a server, while client-side computing devices 141, 142 and 143 may each be a computer or a portable device, used as a user terminal. The illustrated valuation system 101 is implemented with a computing device which is preferably a server and includes common computer components such as processor(s), I/O devices, computer readable media, and network interface (not shown).

The computer readable media stores application program modules and data 103 (such as rating or ranking information). Application program modules contain instructions which, when executed by processor(s), cause the processor(s) to perform actions of a process described herein.

It is appreciated that the computer readable media may be any of the suitable storage or memory devices for storing computer data. Such storage or memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

It is also appreciated that a computing device may be any device that has a processor, an I/O device and a memory (either an internal memory or an external memory), and is not limited to a personal computer. Especially, computer device 102 may be a server computer, or a cluster of such server computers, connected through network(s) 190, which may either be the Internet or an intranet.

Especially, the computer device 102 may be a web server, or a cluster of such servers hosting a website such as an e-commerce site.

In the presence disclosure, a “module” or a “unit” in general refers to a functionality designed to perform a particular task or function. A module or a unit can be a piece of hardware, software, a plan or scheme, or a combination thereof, for effectuating a purpose associated with the particular task or function. In addition, delineation of separate units does not necessarily suggest that physically separate devices are used. Instead, the delineation may be only functional, not structural, and the functions of several units may be performed by a single combined device or component. When used in a computer-based system, regular computer components such as a processor, a storage and memory may be programmed to function as one or more units or devices to perform the various respective functions.

As shown in FIG. 1, the evaluation system 101 includes a parameter computation module 110, an evaluation inquiry module 120, a parameter calling module 130, and a web display generation module 140. The parameter computation module 110 is used for generating various types of evaluation parameters, which will be discussed further below. The evaluation inquiry module 120 is used for notifying the parameter calling module 130 to call the various types of evaluation parameters. The notification may be sent upon receiving a request for evaluation information from a web page. Upon receiving a notification from the evaluation inquiry module 120, the parameter calling module 130 calls the parameter computation module 110 to send the various types of evaluation parameters to the web display generation module 140. Upon receiving the various types of parameters sent from the parameter calling module 130, the web display generation module 140 generates a web page or web form to display the parameters

As will be illustrated further below, the evaluation system is adapted to a multi-faucet evaluation using various types of evaluation parameters which include a type for an overall evaluation and a type for categorical evaluations. The evaluation system may also make use of normal transaction data and post-transaction event records for additional evaluation purposes. Using the system provided in the exemplary embodiments of the present disclosure, more comprehensive evaluation of both parties of a transaction can be achieved. Through obtaining and displaying various types of evaluation parameters, information disclosure of the transaction is enhanced, making evaluation results more objective and reliable.

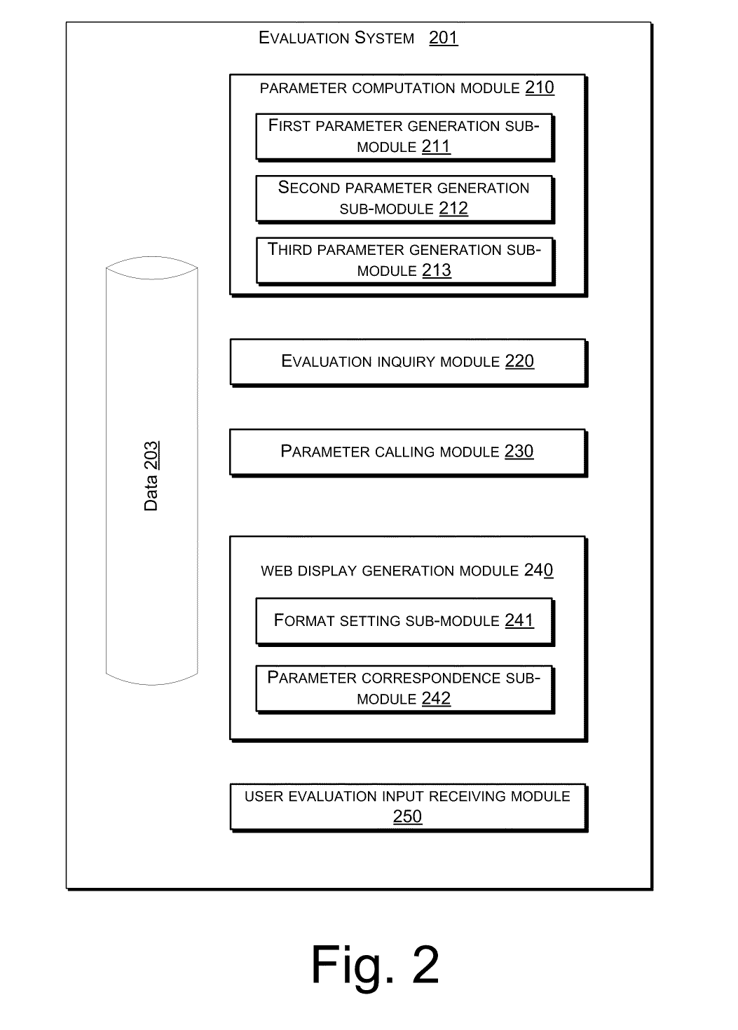

FIG. 2 shows an online evaluation system 201 using an example of a buyer evaluating a seller. The online evaluation system 201 includes a parameter computation module 210, an evaluation inquiry module 220, a parameter calling module 230, a web display generation module 240, and a user evaluation input receiving module 250.

The parameter computation module 210 is used for generating various types of evaluation parameters. The evaluation inquiry module 220 is used for notifying the parameter calling module 230 to call the various types of evaluation parameters upon receiving a request for evaluation information from a web page. The parameter calling module 230 is used for calling the parameter computation module 210 to send the various types of evaluation parameters to the web display generation module 240 upon receiving a notification from the evaluation inquiry module 220. The web display generation module 240 is used for generating a web page displaying the parameters upon receiving them sent from the parameter calling module 230. The user evaluation input receiving module 250 is used for receiving user evaluation of a present transaction entered upon completing the transaction. A typical way for user to enter evaluation information is through clicking on displayed choices.

In one embodiment, upon clicking a seller's link on a web page by the buyer, the evaluation inquiry module 220 submits a request to the parameter calling module 230 to notify the parameter calling module 230 to call the parameter computation module 210 to obtain various types of evaluation parameters, which are then sent to the web display generation module 240. The web display generation module 240 then generates a web page displaying parameters to display to the buyer the various types of evaluation parameters of the seller.

Upon completing a transaction, the parameter computation module 210 stores data of the present transaction, and generates various types of evaluation parameters. In one embodiment, the evaluation parameters include the following four different types: overall evaluation parameters, categorical evaluation parameters, normal transaction data, and post-transaction event records such as complaints, disputes and reimbursements. These different types of evaluating parameters are discussed further below.

The overall evaluation parameters are general rating indicators over the time. This may cover different aspects. Examples of overall evaluation parameters include the number of good ratings, the number of average ratings, the number of poor ratings, and the rate of poor ratings in various time intervals.

The categorical evaluation parameters are more specific rating indicators directed to certain categories and properties. Examples of categorical evaluation parameters include an average score of how consistent a product is with its description in various time intervals, an average score of service quality in various time intervals, an average score of timely delivery in various time intervals, and an average score of price satisfaction in various time intervals.

Normal transaction data are parameters directly related to the transaction itself. These are usually objective properties of the transaction, and not subjective evaluations by users. Examples of normal transaction data include the number of transactions, the amount of money involved in each transaction, the average amount of money involved in a transaction, and the number of buyers.

The post-transaction event records are records of events that occurred after the transact has taken place. Examples of post-transaction event records include complaints, disputes and reimbursements. These may also cover different aspects such as the rate of complaints and disputes, and the rate of reimbursements.

Functionally, the parameter computation module 210 may include sub-modules to generate the various types of evaluation prerogatives. As illustrated, a first parameter computation sub-module 211 is used for generating various types of evaluation parameters from normal transaction data. In one embodiment, the various types of evaluation parameters that can be generated from transaction data include parameters of four dimensions: the number of transactions, the amount of money involved in each transaction, the average amount of money involved in a transaction, and the number of buyers. Upon completing a transaction, the first parameter computation module 211 stores details of the present transaction into the system's transaction details table, and triggers a function of updating the summary information of transaction data. As a result, in the system's database, the transaction information summary table is updated, which includes updating the number of transactions, the amount of money involved in the transaction, the average amount of money involved in a transaction, and the number of buyers.

In the above updated information, information of the present transaction is included. For example, the number of transactions is increased by one, and the average amount of money involved in a transaction is re-computed, etc. If the purchase is made by a new buyer, the number of buyers is increased by one.

A second parameter computation sub-module 212 is used for generating various types of evaluation parameters from buyers' evaluations of a seller. In one embodiment, these evaluation parameters cover multiple dimensions of the buyers' overall evaluations of the seller, including the number of good ratings, the number of average ratings, the numbers of poor ratings, and the rate of poor ratings in various time intervals. These evaluation parameters may also cover multiple dimensions of the buyers' categorical evaluations of the seller, including average scores of how consistent a product is with its description in various time intervals, average scores of service quality (e.g., friendliness and helpfulness) in various time intervals, average scores of timely delivery in various time intervals, and average scores of price satisfaction in various time intervals.

Buyers' evaluations of a seller are entered by buyers upon completing a transaction. A buyer conducts evaluation survey of a seller on a web page. Contents of the evaluation may include both overall evaluation and categorical evaluation. The buyer conducts the evaluation by way of clicking through various choices. Upon completing the click-through, the evaluation is submitted by clicking a submission button. The second parameter computation sub-module 212 stores data of the present evaluation at a back end. The back end operates on an evaluation details table stored in the database, and adds a transaction record. For example, the back end writes into the record various data including the buyer ID (i.e., an identifier of the buyer), the seller ID, a rating value of the overall evaluation, and rating values of each dimension of categorical evaluations.

The back end updates an evaluation information summary table in the database using the present transaction's evaluation result. Contents to be updated include both the overall evaluation information and the categorical evaluation information. The overall evaluation information includes the number of good ratings in various time intervals, the number of average ratings in various time intervals, the number of poor ratings in various time intervals, and rate of poor ratings in various time intervals. The categorical evaluation information includes average scores of how consistent a product is with its description in various time intervals, average scores of service quality (e.g., friendliness and helpfulness) in various time intervals, average scores of timely delivery in various time intervals, and average scores of price satisfaction in various time intervals.)

A third parameter computation sub-module 213 is used for generating various types of evaluation parameters from the post-transaction event records such as complaints, disputes and reimbursements. This type of evaluation parameters may include two dimensions such as the rate of complaints and disputes, and the rate of reimbursements. If reimbursement has occurred after a transaction, the third parameter computation sub-module 213 updates a summary table of complaints, disputes and reimbursements based on the present reimbursement, adds a new imbursement entry to the table, and re-computes the rates of reimbursements in various time intervals. By the same token, if a new complaint or dispute has occurred, the third parameter computation sub-module 213 updates the summary table in the database of the back end based on the pursuant data, and re-computes the rates of complaints and disputes in various time intervals.

The web display generation module 240 also includes several sub-modules in a functional sense. A format setting sub-module 241 is used for setting up a format of a web page displaying the evaluation parameters. The various types of evaluation parameters are displayed according to a certain format, which includes positions where each parameter is to be displayed, and time intervals whose corresponding parameters are displayed (i.e., the format sets a time dimension for the parameters to be displayed). For example, an overall evaluation display may include displaying evaluation parameters associated with one month, three months, and one year, to give the user more detailed evaluation information.

A parameter correspondence sub-module 242 is used for filling in the various types of evaluation parameters according to the display format of the web page set by the format setting sub-module 241.

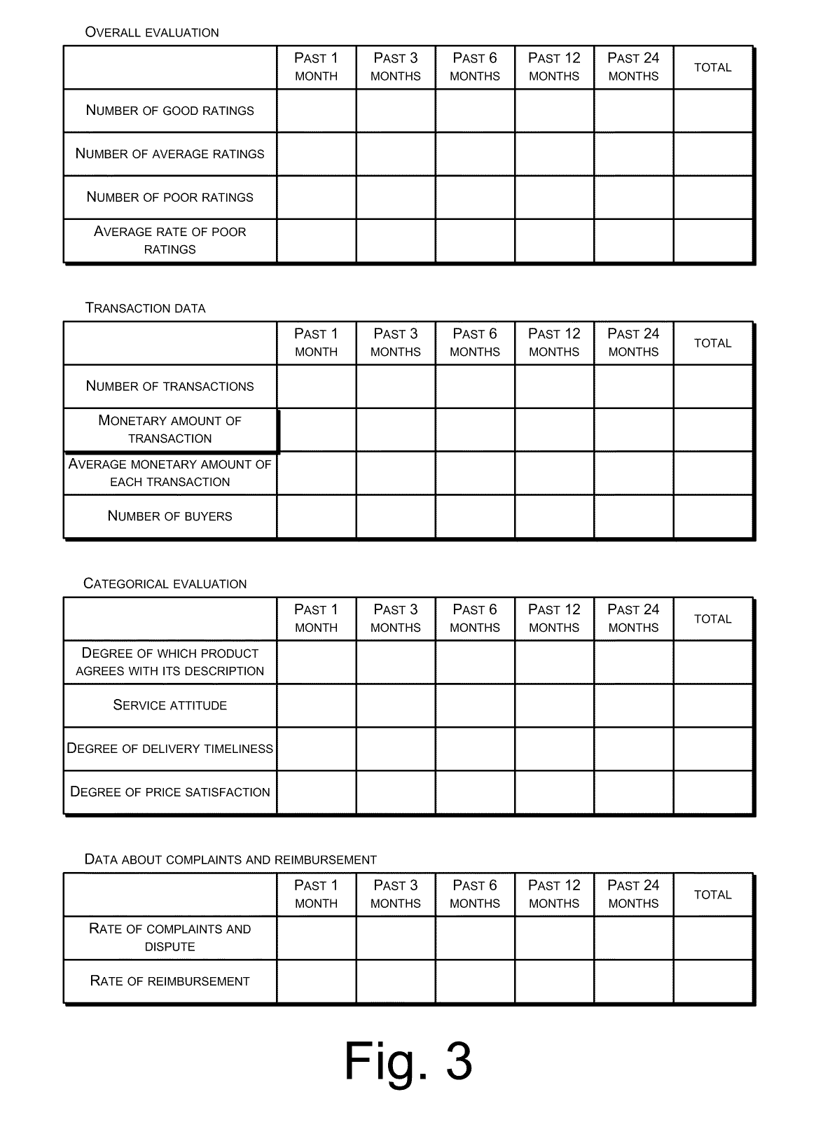

FIG. 3 shows an exemplary display of various types of evaluation parameters of a seller. The displayed data are formulated based on the web page format set by the format setting sub-module 241. As shown in FIG. 3, the multiple evaluation indicators (four in each major type as illustrated) of a seller are displayed in different time dimensions (intervals). This allows a buyer to clearly understand a seller's condition of each period in the past, and to understand changes and trend about the seller's transactions, for example whether the ratings are increasing or decreasing, whether the seller has been operating for a long time or has had an explosively increasing number of transactions within just a short period of time recently.

Displaying a time dimension (e.g., various time intervals) may help reveal fake transactions that are created within a short period of time, or flaws in temporary transaction histories resulting from people mutually contributing bogus credibility. Given the revealed information, a buyer may prefer to trust a seller who has had steady transactions over a long period of time to a seller having a lot of transactions within just a month.

Among the various evaluation parameters, the overall evaluation relates to buyers' overall impression of a seller, and has an advantage of providing a simple and quick way for a buyer to evaluate and understand the seller. Categorical evaluation may be viewed as a break-up of the overall evaluation. In this sense, the overall evaluation may be considered a summary of the various categorical evaluations. Both overall evaluation and categorical evaluation are obtained from the evaluations entered by transaction parties (e.g., buyers) with regard another transaction party (e.g., a seller). Under normal circumstances, a result of the categorical evaluation and a result of the overall evaluation should be consistent with one another.

In order to prevent a user from making excessively repetitive evaluations to create bogus credibility, multiple evaluations of a seller by a buyer within a certain period of limit time (e.g., half a year) are only counted as one. An exemplary counting rule of such repetitive multiple evaluations is described as follows.

Count one good rating if the number of good ratings is greater than the number of poor ratings in multiple evaluations; count one poor rating if the number of poor ratings is greater than the number of good ratings in the multiple evaluations; and count one average rating if the number of poor ratings equals number of good ratings in the multiple evaluations.

If a buyer does not conduct an evaluation after a transaction, the system may take it as a good rating by default.

In one embodiment, the rate of poor ratings, rather than the rate of good ratings, is chosen as a metric of the overall evaluations. This may have an advantage for several reasons. First, because rate of good ratings of sellers are usually quite high, typically above 97%, a seller having a 98% rate of good ratings, and a seller having a 99.5% rate of good ratings do not seem to be that difference to most buyers if viewed from a perspective of rate of good ratings. But if viewed from a perspective of rate of poor ratings, their rate of poor ratings may be 2% and 0.5% respectively, and a different of four times.

Second, what a buyer really concerned is not how high a ratio of good ratings a seller may have. Rather, the buyer is more concerned about what the seller's rate of poor ratings is, how likely a problem would occur to trade with the seller, and how high a risk may be.

Assume, for example, one seller have completed one hundred seller transactions since registration, and received ninety-seven good ratings, two average ratings and one poor rating, and another seller have also completed one hundred seller transactions, and received ninety-seven good ratings, zero average ratings and three poor rating.

The first seller's rate of good ratings is:

97/(97+2+1)=97%;

The second seller's rate of good ratings is:

97/(97+3)=97%;

The first seller's rate of poor ratings is:

1/(97+2+1)=1%;

The second seller's rate of poor ratings is:

3/(97+3)=3%.

Both sellers are the same in view of rate of good ratings. However, the second seller's rate of poor ratings is three times the first seller's rate of poor ratings. As such, a buyer may learn that trading with the second seller is riskier than trading with the first seller.

In one embodiment, the four dimensions of the categorical evaluation each adopt a rating scheme using multiple discrete points. For example, a five-point rule, which provides five different grades for a buyer to choose, may be used. A seller's score in each dimension is an average of evaluations received from buyers. In this five-point scheme, a rating of one point represents “very poor”, two points represents “poor”, three points represents “average”, four points represents “good”, and five points represents “very good”.

If a buyer assigns scores to a same seller multiple times within half a year, only an average score (an average of all scores given by the same buyer within the half year period) is recorded as a single score, and used with scores from other buyers to obtain an overall average score for the seller. This prevents a buyer from increasing his/her weight of evaluation by submitting multiple evaluations. If a user does not conduct an evaluation, the system automatically gives a score of five points.

For example, a seller conducts ten transactions within half a year, with four transactions being associated with a same buyer. The buyer assigns five points for service quality (e.g., friendliness and helpfulness) of the seller in one transaction, and assigns four points to the service quality of each of the other three transactions. Under this condition, the seller's service quality score given by the buyer is:

(5×1+4×3)/(1+3)=4.25.

If buyers associated with the other six transactions are all different, and they have given to the seller's service quality these scores: three, three, four, four, five, and five, the seller's overall average score for service quality is:

(4.25+3+3+4+4+5+5)/7≈4.0357.

Even the same rate of poor ratings and categorical evaluation scores, the actual transaction histories of two sellers may be very different. For example, the first seller may be a new seller who has had conducted only a single transaction, and second seller may have had five years of experience already. Overall reputation and possible degree of risk a seller has in the whole market are greatly related to history data such as his/her transaction history and the number of transactions. Therefore, transaction data, and complaints, disputes and reimbursements are given as a reference for buyers.

For example, suppose one seller has conducted ten transactions, and has none poor rating (zero rate of poor ratings), and 4.5 score for delivery time. Another seller has conducted one hundred transactions, and also none poor rating, and 4.5 for delivery time score. In view of the rate of poor ratings and delivery time, both parties are the same. However, the second seller clearly has a better overall reputation.

The system may compute an overall credibility score based on past ratings. Preferably, however, the presently disclosed method does not provide such an overall credibility score, recognizing that it is hard to have an reliable algorithm of computing a meaningful overall score based on the overall evaluation and the categorical evaluation. This because buyers may give different overall scores to a seller based on the same overall evaluation, categorical evaluation, and transaction data. Each buyer may have his or her own way to interpret the evaluation data and get an overall score. If the system provides an overall credibility score, this may be misleading, and violating original intentions of most buyers.

If the system needs to compute an overall credibility score of a seller for a management purpose or an advisory purpose, a single overall credibility score may not be sufficient to handle all situations. The system may compute various credibility scores or rankings according to practical needs. The system may set up various weights to compute various credibility scores based on the above multi-dimensional data. In one embodiment, such results are not open to buyers but to the sellers only. In this case, computing algorithms may need to be transparent to the seller to be persuasive.

To apply the evaluation method to a system which has used a conventional evaluation scheme and used an overall credibility score, the existing computing algorithm for overall credibility score may be kept during a transition period between old and new evaluation schemes. However, certain upgrades may be made to make it more difficult to create bogus credibility. One exemplary scheme is to count the overall evaluation made by a seller with regard to a seller just once in every half a year. If the buyer has made multiple evaluations of the seller, only one score is computed based on the multiple evaluations. The system may restrict the maximum monthly increase of each seller's credibility by a cap. For example, a seller's credibility may maximally rise by one level each month. Accordingly, a seller would need at least five months to attain a rating of five hearts, and at least ten months to attain five diamonds. This restriction prevents any seller from attaining a diamond status within just a few days by creating bogus credibility, and also reduces unfair results between sellers of virtual goods and sellers of real goods. Moreover, most sellers of real goods having normal transactions are not affected by this cap, as the cap is not surpassed under most circumstances. This scheme does not negatively affect the transactions of the e-commerce website. On the contrary, it may improve the transactions of the website as a whole by because the scheme can be beneficial to legitimate sellers by making it more difficult and more costly to create bogus credibility.

The system provided by the exemplary embodiments of the present disclosure may achieve a more comprehensive evaluation of a seller. The system enhances information disclosure of the transactions and helps buyers better understand sellers by obtaining and displaying various types of evaluation parameters, and making the evaluation results more objective and reliable.

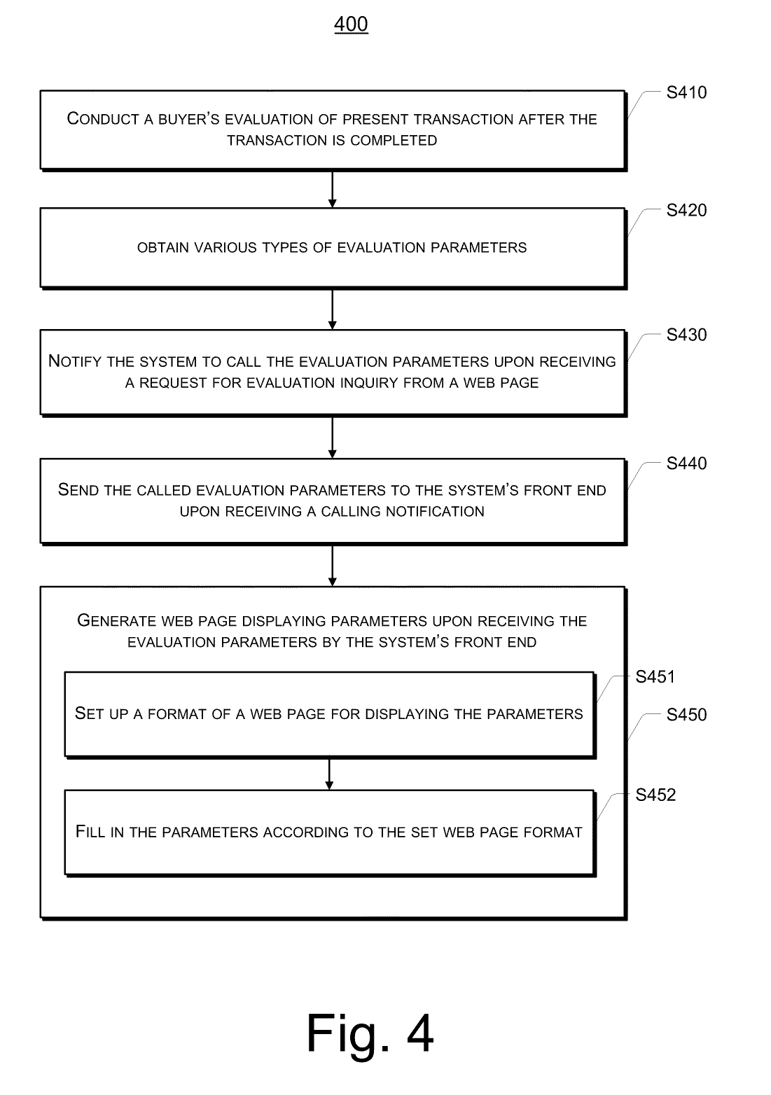

FIG. 4 shows an exemplary process 400 in which a seller is evaluated by buyers. The exemplary process 400 may be understood in the context of an online evaluation method. The process 400 is described as follows.

Block S410: Upon completing a transaction, the system allows the buyer to evaluate the present transaction by way of clicking through various choices provided to the buyer by the system. For example, after a transaction is completed, the buyer conducts an evaluation survey of the seller on a web page. Contents of the evaluation include overall evaluation and categorical evaluation. The buyer conducts the evaluation survey by way of clicking through various choices, and submits the evaluation upon completing the survey. The web page sends the evaluation to the system for processing.

Block S420: The system computes various types of evaluation parameters disclosed herein. For example, after the transaction is completed, the system stores data of the present transaction. Based on the data of the present transaction, the system updates a transaction information summary table, an evaluation information summary table, and a summary table of post-transaction event records (such as complaints, disputes and reimbursements) to compute various types of evaluation parameters disclosed herein.

Block S430: Upon receiving a request for evaluation information from a web page, the system calls the various types of evaluation parameters. For example, as the buyer clicks the seller's link on the web page, the system's front end sends a notification to a back end to request that the various types of evaluation parameters be called.

Block S440: Upon receiving a calling notification, the system sends the called various types of evaluation parameters to the system's front end. For example, after the notification sent from the system's front end is received, the back end of the system reads from a database the above-mentioned summary tables to the front end.

Block S450: The system generates web page displaying parameters after the front end has received the various types of evaluation parameters. An exemplary process of generating web page displaying parameters upon receiving the various types of evaluation parameters by the system's front end is represented by sub-blocks S451 and S452, which are described below.

Sub-Block S451: The system sets a format of the web page displaying parameters. The various types of evaluation parameters are displayed according to a certain format, which includes positions where the parameters are to be displayed, and time intervals of to be displayed. For example, an overall evaluation may display parameters for one month, three months, and one year, to help a user obtain information in further detail.

Sub-Block S452: The system allows the various types of evaluation parameters to be filled according to the set web page format. For example, by displaying the several types of indicators in different time dimensions, the system allows a buyer to clearly understand a seller's condition of each period in the past, and to understand the changes and trends of the seller's transactions.

Based on the data provided by the back end, the front end generates a web page to display the past performance of the seller to the buyer.

The system and the method illustrated in FIG. 1 and FIG. 2 may also be used for evaluating a buyer buy sellers. Upon completing a transaction, a seller conducts an evaluation survey of a buyer on a web page. The process used for a seller to evaluate a buyer is similar to the process used for a buyer to evaluate a buyer.

The actual evaluation parameters used for evaluating a buyer, however, may not be the same as that used for evaluating a seller, as the evaluating parameters should be pursuant to the characteristics of the party that is being evaluated.

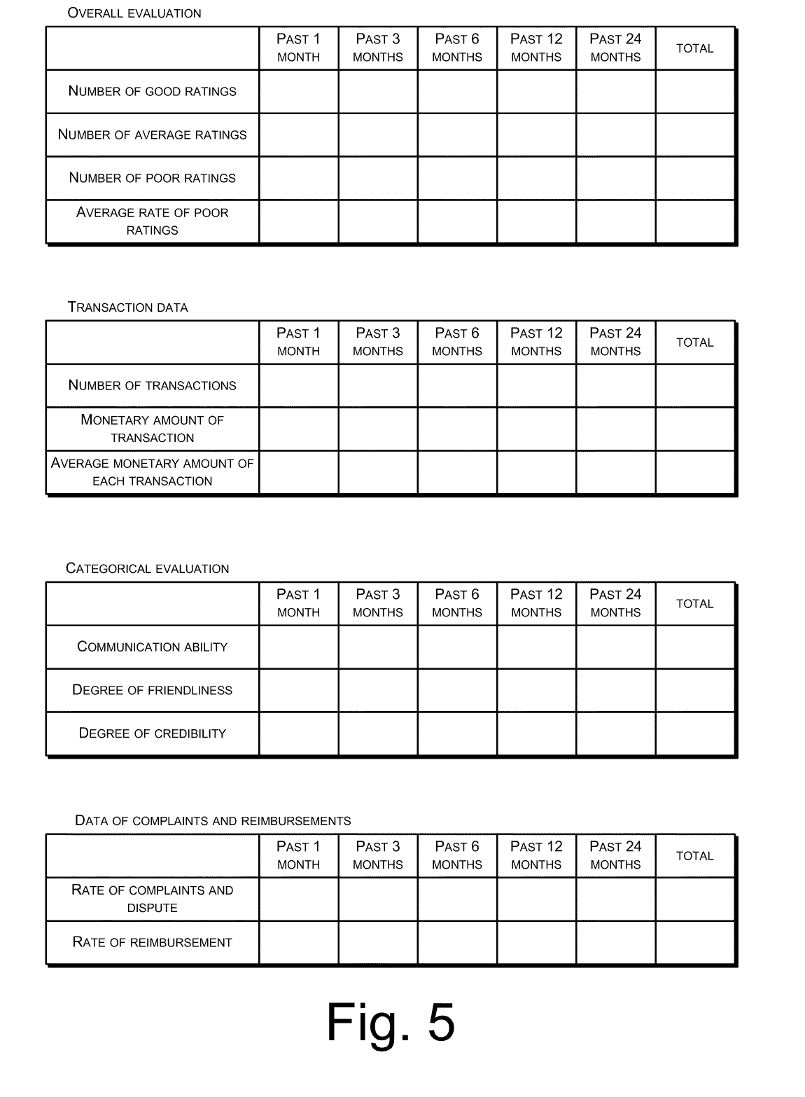

FIG. 5 shows an exemplary display of various types of evaluation parameters of a buyer. The displayed data are formulated based on the web page format set by the system. As shown in FIG. 5, by displaying the four indicators in different time periods a seller is allowed to clearly understand a buyer's condition in each period in the past. Displaying time dimension exposes bogus transactions that are created within a short period of time, or temporary flaws in transaction histories resulting from people mutually contribute bogus credibility. Comparatively, a seller may prefer to trust a buyer who has transactions in a long period of time, rather than a buyer having a lot of transactions within one month.

The above-described process of preventing creation of bogus credibility by a seller may also be used for creation of bogus credibility by a buyer. Specifically, evaluations of a buyer by a seller within a certain period (e.g., half a year) are counted as only one evaluation by averaging the multiple evaluations. In one embodiment, the system does not generate an overall credibility score, which can be more directly affected by activities of creating bogus credibility. Usually, the scores of categorical evaluation are less affected by such activities. In addition, the transaction data is displayed according to various time intervals. The transaction data can clearly reflect the time intervals in which transactions are concentrated. In case of bogus evaluation activities, associated transactions are often concentrated in a recent period (e.g., in recent one month) with few or none earlier transaction.

The method and the system provided in the exemplary embodiments of the present disclosure increase the cost of bogus evaluation activities and make it more difficult to illegitimately increase a user's credibility. Furthermore, the system considers the interests of both new and old buyers and sellers to balance them. In addition, the rate of poor ratings, instead of the rate of good ratings, is used in some embodiments to balance the interests of both transaction parties.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. An online evaluation method, comprising:
receiving evaluation data submitted by users of a first type to evaluate a user of a second type;
computing multiple types of evaluation parameters including at least an overall evaluation type and a categorical evaluation type using the received evaluation data;
calling the multiple types of evaluation parameters upon receiving a request for evaluation information of the user of the second type from a web page;
sending the multiple types of evaluation parameters to a front end; and
displaying the multiple types of evaluation parameters on a web page through the front end.

2. The method as recited in claim 1, wherein the users of the first type are buyers, and the user of the second type is a seller.

3. The method as recited in claim 1, wherein the overall evaluation type has a plurality of general evaluation parameters including at least a total number of good ratings, a total number of poor ratings, and an average rate of poor ratings.

4. The method as recited in claim 1, wherein the categorical evaluation type has a plurality of specific evaluation parameters each representing a specific category of user performance.

5. The method as recited in claim 1, wherein the multiple types of evaluation parameters further include one or more evaluation parameters based on normal transaction data.

6. The method as recited in claim 1, wherein the multiple types of evaluation parameters further include one or more evaluation parameters based on post-transaction event records.

7. The method as recited in claim 1, wherein at least one of the multiple types of evaluation parameters is computed for a plurality of time intervals.

8. The method as recited in claim 1, wherein the multiple types of evaluation parameters displayed on the website do not include an overall credibility score of the user of the second type.

9. The method as recited in claim 1, further comprising:
sending an evaluation survey to a respective one of the users of the first type to collect the evaluation data upon completing a transaction.

10. The method as recited in claim 1, wherein displaying the multiple types of evaluation parameters on a web page through the front end comprises:
configuring a format of displaying parameters on the web page; and
displaying the multiple types of evaluation parameters on the web page according to the format.

11. The method as recited in claim 1, wherein the user of the second type is a seller, and the multiple types of evaluation parameters include at least some of the following parameters: total number of transactions, amount of money involved in a transaction, average amount of money involved in a transaction, total number of buyers, total number of good ratings received, total number of average ratings received, total number of poor ratings received, a rate of poor ratings, an average score of how consistent a product is with its description, an average score of service quality, an average score of timely delivery, an average score of price satisfaction, a rate of complaints and disputes, and a rate of reimbursements.

12. The method as recited in claim 1, wherein the user of the second type is a buyer, and the multiple types of evaluation parameters include at least some of the following parameters: a total number of sellers dealt with, an average score of communication ability, an average score of friendliness, and an average score of credibility.

13. An online evaluation system comprising a server computer which is adapted to:
receive evaluation data submitted by users of a first type to evaluate a user of a second type;
compute multiple types of evaluation parameters including at least an overall evaluation type and a categorical evaluation type using the received evaluation data;
call the multiple types of evaluation parameters upon receiving a request for evaluation information of the user of the second type from a web page;
send the multiple types of evaluation parameters to a front end; and
display the multiple types of evaluation parameters on a web page through the front end.
